(19) United States
(12) Patent Application Publication
(10) Pub. No.: US 2026/0117127 A1
(43) Pub. Date: Apr. 30, 2026

(54) LIGNOCELLULOSIC VALORIZATION FOR ASPHALT PRODUCTS

(71) Applicant: Western Research Institute, Laramie, WY (US)

(72) Inventors: Jeramie ADAMS, Laramie, WY (US); Seth BASSHAM, Laramie, WY (US); Wyatt PHILLIPS, Laramie, WY (US); Joe AULT, Laramie, WY (US); Alex LITERATI, Laramie, WY (US); Yogesh KUMBARGERI, Laramie, WY (US)

(73) Assignee: Western Research Institute, Laramie, WY (US)

(21) Appl. No.: 19/371,706

(22) Filed: Oct. 28, 2025

Related U.S. Application Data
(60) Provisional application No. 63/713,218, filed on Oct. 29, 2024.

(51) Int. Cl. C10C 3/02; C08L 9/06; C08L 97/00; C10C 3/06

(52) U.S. Cl. CPC C10C 3/026; C08L 9/06; C08L 97/00; C10C 3/06

(57) ABSTRACT

Methods of valorization of lignocellulosic feedstocks via bio-solvents to produce asphalt products are provided. In one embodiment, a method of valorizing a lignocellulosic feedstock includes: providing a lignocellulosic feedstock; contacting the lignocellulosic feedstock with a bio-solvent at a temperature selected from the range of 120° C. to 450° C., thereby generating a liquid phase and a residue, the residue being an insoluble solid; distilling the liquid phase, thereby generating a distillate and a product; and producing an asphalt binder material, wherein the asphalt binder material comprises the product.

### CROSS-REFERENCE TO RELATED APPLICATIONS

This application claims the benefit of priority to U.S. Provisional Patent Application No. 63/713,218, filed Oct. 29, 2024, which is hereby incorporated by reference in its entirety.

### BACKGROUND OF INVENTION

Based on market analysis from 2024, approximately 128 million metric tons of primary asphalt (bitumen) are used globally each year, a figure projected to grow. With the vast majority of asphalt used in pavement for road construction, the reliance on petroleum-derived binders presents a significant environmental challenge related to resource depletion, reduced production due to the energy transition, and carbon emissions. This large-scale fossil fuel dependence offers a substantial opportunity to integrate sustainable alternatives, such as those derived from lignocellulosic feedstocks, into the global asphalt market.

The massive and growing consumption of asphalt highlights the potential impact of even a partial substitution. Replacing just a fraction of the petroleum-based bitumen with bio-alternatives could lead to a significant reduction in the construction industry's carbon footprint. Bio-substitution is one method for generating carbon removal credits. While challenges remain regarding performance consistency and production costs, there exists an opportunity for a global impact via improved processing of existing bio wastes streams.

It can be seen from the foregoing that there remains a need in the art for systems and methods for improved asphalt binders and modifiers.

### SUMMARY OF THE INVENTION

In one embodiment, a method of valorizing a lignocellulosic comprises providing a lignocellulosic feedstock; contacting the lignocellulosic feedstock with a bio-solvent at a temperature selected from the range of 120° C. to 450° C., thereby generating a liquid phase and a residue, the residue being an insoluble solid; distilling the liquid phase, thereby generating a distillate and a product; producing an asphalt binder material, wherein the asphalt binder material comprises the product.

In one embodiment, the method comprises solvolysis of the lignocellulosic feedstock via the bio-solvent. In one embodiment, the bio-solvent is derived from one or more agricultural crops. In one embodiment, the bio-solvent comprises a C4 to C38 carbon chain. In one embodiment, the bio-solvent comprises a C8 to C16 carbon chain. In one embodiment, the bio-solvent comprises a C16 to C26 carbon chain.

In one embodiment, the bio-solvent comprises one or more fatty acids, anhydrides, fatty alcohols, fatty amines, fatty aldehydes, or combinations thereof. In one embodiment, the bio-solvent is a bifunctional solvent. In one embodiment, the method comprises producing the bio-solvent from one or more agricultural crops.

In one embodiment, the lignocellulosic feedstock comprises cellulose, hemicellulose, lignin, or a combination thereof. In one embodiment, the method comprises preparing the lignocellulosic feedstock from a paper, construction, sawmill, or forestry waste stream. In one embodiment, the lignocellulosic feedstock comprises corn stover, corn husks, wheat, rice, bamboo, strow, barley, palm, sugar cane, beet pulp, sorghum stalks, soybean straw, okara, potato waste, soybean hulls, flour, sugar cane bagasse, leaves, rice husks, grasses, wood, hemp, coco nut husks, cocoa waste, coffee plant and fruit waste, coffee grounds, manure, or combinations thereof. In one embodiment, wherein the lignocellulosic feedstock comprises paper waste, cardboard, natural fabrics or combinations thereof. In one embodiment, the lignocellulosic feedstock comprises proteins, amino acids, nucleic acids, lipids, or combinations thereof. In one embodiment, the lignocellulosic feedstock is derived from algae, bacteria, mold, fungus, and/or lichen.

In one embodiment, the contacting step occurs at a temperature selected from the range of 200° C. to 380° C. In one embodiment, the contacting step occurs at a pressure selected from the range of 5 psig to 500 psig. In one embodiment, the contacting step has a duration selected from the range of 1 minute to 480 minutes.

In one embodiment, the contacting and distilling steps are performed via batch processing. In one embodiment, the contacting and distilling steps are performed via continuous processing.

In one embodiment, the method comprises oxidizing the product via air or a chemical oxidizing agent. In one embodiment, the method comprises contacting the product with an antioxidant material. In one embodiment, the antioxidant material comprises a phenolic antioxidant, a radical scavenger antioxidant, a sulfur-based antioxidant, a phosphite-based antioxidant, a metal-based antioxidant, or a combination thereof.

In one embodiment, producing the asphalt binder material comprises blending the product with a polymer. In one embodiment, the polymer is an SBS polymer or reactive terpolymer.

In one embodiment, the method comprises producing a roofing material, asphalt, coating, or sealant using the asphalt binder material.

In one embodiment, the bio-solvent is a first bio-solvent, and the contacting step comprises: contacting the lignocellulosic feedstock with the first bio-solvent at a first temperature and for a first duration in a first extraction stage; and contacting the lignocellulosic feedstock with the bio-solvent at a second temperature and for a second duration in a second extraction stage; wherein the first temperature is at least 20° C. greater than the second temperature, and wherein the second duration is at least 1.2 times greater than the first duration. In one embodiment, the first bio-solvent is the same as the second bio-solvent. In one embodiment, the first bio-solvent is different than the second bio-solvent.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: SEC chromatogram for a PG 58-28 (BI-0003) petroleum asphalt binder and select lignocellulosic products using an ELS detector. Internal standards were used to calibrate the MW (254, 1,300, and 13,000 Daltons) at different retention times.

FIG. 2: SEC chromatogram for a PG 58-28 (BI-0003) petroleum asphalt binder and select lignocellulosic products using an optical absorbance detector set at 350 nm. For petroleum this wavelength detects most aromatic molecules containing 2-3+ fused ring aromatics (including asphaltenes). Internal standards were used to calibrate the MW (254, 1,300, and 13,000 Daltons) at different retention times.

FIG. 3: SEC chromatogram for a PG 58-28 (BI-0003) petroleum asphalt binder and select lignocellulosic products using an optical absorbance detector set at 500 nm. For petroleum this wavelength is highly sensitive to asphaltenes. Internal standards were used to calibrate the MW (254, 1,300, and 13,000 Daltons) at different retention times.

FIG. 4: Black space plot for dynamic shear rheometer data collected using 4 mm parallel plates. Frequency sweeps were performed at several isotherms from −30, −15, 0, 15, 30 and 45° C. Lignin A is the product from Table 1 produced with a higher amount of solvent and the PG 64-22 control is a standard petroleum asphalt.

FIG. 5: shows the derivative of TGA weight loss curves for lignin, lignin residue, cellulose and cellulose residue. As can be seen, after thermochemical extraction the residual organic content is much less reactive (less pyrolytic carbon).

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

As used herein, the term “bio-solvent” means a solvent produced from renewable biomass sources like plants, crops, and agricultural waste. Dodecanol derived from coconut oil is one example of a bio-solvent.

In an embodiment, a composition or compound of the invention, such as an alloy or precursor to an alloy, is isolated or substantially purified. In an embodiment, an isolated or purified compound is at least partially isolated or substantially purified as would be understood in the art.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

Lignocellulosic feedstocks can be valorized into smaller molecules using solvolysis methods, typically with water or small carbon length alcohols. The purpose of these processes is generally to provide small molecule phenolic chemical feedstocks, or for the production of liquid fuels.

As disclosed herein, bio-solvents, derived from bio-oils and fats, may be used to valorize lignocellulosic feedstocks from industrial waste, commercial products, or post-consumer waste to produce a non-distillable heavy fraction that is useful for producing asphalt products such as alternative binders, roofing materials, coatings, additives, sealants, or recycling agents. These products are biogenic carbon, thus when used for infrastructure of building materials they become a carbon sink by storing CO2. The alternative binders can be used as pure bio-based binders or coatings, or they can be substituted for a portion of petroleum content in traditional products to improve the carbon footprint of the blend.

The materials may be oxidized with air, chemically, or further reacted with other chemistries to produce new products with larger molecular weight, polarity, and degree of crosslinking. This process can be accelerated with time, temperature, pressure or catalyst to change the chemical composition or to increase oligomerization or polymerization for the same or other material applications.

The heavy non-distillable, yet meltable, flowable, or dilutable properties allow the material to be transportable by pipeline, rail, ship, or truck. Lower viscosity products can be produced and used as heavy fuel feedstocks.

In one aspect, the extraction step may include reaction of a fatty alcohol to form ester and ether groups on smaller lignocellulosic molecular fragments, typically reacting with the abundant oxygen containing functional groups in the feedstock. In one aspect, the extraction step may include alkylation reactions, such as Friedel Crafts type of reactions as the aromatic moieties with the fatty alcohols. In one aspect, these reactions may also increase the hydrophobicity, improve the solubility, and/or impart flexibility and viscoelastic properties. In one aspect, the extraction step may include a combination of hydrothermal liquefaction and solvolysis.

In one aspect, the selection of the bio-solvents is chosen so that the chain length gives appropriate properties. Chain lengths from C4 to C38 will give different products due to the self-attraction of the alkyl chains, crystalline tendency of chains, molecular weight, and reactions within reactive portions of some alkyl chains. A more optimum viscoelastic response—similar to paving grade asphalt binder—for alternative binders with this technology can be readily achieved using C8 to C16 chain lengths. Stiffer materials with higher temperature glass transitions, viscosity, or softening point can be achieved by using longer chain lengths in the C16-C26 range, and waxy like materials can be produced when using longer chain lengths with fully saturated or mostly saturated chains. The biogenic solvents can also be produced from non-lipid feedstocks through catalytic processes from sugars and other biomass feedstocks.

Unsaturated bonds (such as double bonds, olefin, or vinyl), functionalized unsaturated bonds, and branching can be used to tune the viscoelastic and crystalline response of the material mainly attributed to the glass transition properties.

Bifunctional solvents can be used to generate functionalized products, or to produce new oligomeric or polymerized products. The functionalized products can have properties such as higher or lower hydrophobicity, changes in surface tension, interfacial activity, wetting, adsorption, vapor pressure, heat capacity, lubricity, antimicrobial properties, state of matter, crystalline behavior, glass transition properties, thermal and chemical stability, electrical properties, and other properties. Alternatively, they can serve as functional groups for additional chemical modification to tune molecular weight, solubility, glass transition temperature, to name a few.

The thermochemical process conditions—such as time, temperature, pressure, and mixing—to produce these products can be used to tune the degree of alkylation which also changes the chemical, viscoelastic, and crystalline behavior when using the same alkyl chains.

Due to cost or availability, the same solvents derived from the petroleum industry, or from Fischer-Tropsch processing using gasification syngas from diverse carbonaceous feedstocks, can be used in the same process to produce the same performance materials as hybrid bio/petroleum products. This strategy may also be useful to extend the availability of bio oils.

Lignocellulosic feedstocks that can be transformed into asphalt products can be from industrial waste streams enriched in lignin, hemicellulose, cellulose, or a combination. Of particular interests are wastes from the paper, construction, and sawmill industry. Wastes can be from the agricultural industry such as corn stover, corn husks, wheat, rice, bamboo, strow, barley, palm, sugar cane, beet pulp, sorghum stalks, soybean straw, okara, potato waste, soybean hulls, flour, sugar cane bagasse, leaves, rice husks, grasses, wood, hemp, coco nut husks, cocoa waste, coffee plant and fruit waste, coffee grounds, manure, forest logging residue and wastes, vegetation clearing waste, and others. They can also be from post-consumer waste such as paper, cardboard and textiles and fabrics from natural fibers. Other feedstocks can be from landscaping wastes or plant wastes due to seasonal changes. Amenable lignocellulosic feedstocks may also contain proteins, simple carbohydrates, sugars, amino acids, nucleic acids, lipids, and other carbohydrates.

Natural, cultivated, or waste lignocellulosic feedstocks form algae, bacterial, mold, fungus, and lichen can be used. Marine and aquatic derived feedstocks of kelp, seaweed, grasses, and algae can be used.

Chitin rich feedstocks such as exoskeletons form anthropoids can be used.

Effective solvents are fatty acids, anhydrides, fatty alcohols, fatty amines and fatty aldehydes.

The process used can be batch, semi-batch flow though, or continuous. The process can be performed so that insoluble extracted residue and ash are separated from the liquid products or so that they are co-produced. Post processing of the reaction mixture may include flashing, liquid-liquid extraction, atmospheric distillation, or vacuum distillation. The process may involve an initial valorization of the feedstock followed by a secondary treatment within the same mixture at the same conditions or different conditions. Products produced after a distillation process may be further modified by further reaction with the same solvent or with a different solvent.

The temperature range for the valorization with the solvents occurs between 120-450° C., preferably 200-380° C. With pressures from 2×10⁻⁵ to 5×10³ psi, preferably between 5 psi to 500 psi. Residence time can be from 0.1 minutes to 10,000 minutes, preferably between 1 minute to 480 minutes.

The oxidation stability of the liquefied bio-based materials may be enhanced by using antioxidants from organics, phenolics, radical scavengers, sulfur-based compounds, phosphites such as triphenyl phosphite, or metal-based compounds such as ZDC or ZDDP.

The liquefied bio-based materials properties maybe tuned by blending with elastomeric or plastomeric polymer. Of particular interest are styrene-butadiene-styrene (SBS) polymers and reactive terpolymers. The performance of these polymers may be enhanced using cross linking agents such as sulfur or other organic or inorganic agents. There may also be a synergistic effect on cross-linking properties and oxidation by combining SBS with antioxidants such as zinc diethyldithiocarbamate (ZDC).

The invention can be further understood by the following non-limiting examples.

### Example 1: Batch Reactor

Various lignocellulosic feedstocks were treated in a batch autoclave reactor with dodecanol as the solvent. Reactions were heated to 365° C. under an initial 500 psi nitrogen with mechanical stirring for various times. Autogenous pressure was maintained throughout the reaction. After completion of the reaction the reactor was cooled to ambient, vented, and the insoluble extraction residue was filtered. The residue (non-liquefied portion) was rinsed with acetone or toluene, dried in a vacuum oven, and weighed. The soluble portion was vacuum distilled to remove excess solvent, lighter decomposition products from the solvent and lignin, and heavier decomposition products from the solvent. Table 1 shows some experimental details and extraction yield data for various lignocellulosic feedstocks processed by this method.

TABLE 1
Select experimental details and extraction yield for various lignocellulosic feedstocks
thermochemically treated with dodecanol in a stirred batch reactor.

| | Dodecanol | | | | |
|---|---|---|---|---|---|
| | Solvent | Extraction | Starting | Extraction | Time |
| Feedstock | Volume (mL) | Yield (%) | Weight (g) | Residue (g) | (hr) |
| Lignin A (Hardwood, | 50 | 84.33% | 6.00 | 0.94 | 4 |
| non-Kraft) | | | | | |
| Lignin A (Hardwood, | 18.00 | 63.56% | 6.01 | 2.19 | 4 |
| non-Kraft) | | | | | |
| Lignin B (non-Kraft) | 50 | 87.71% | 6.02 | 0.74 | 4 |
| Lignin C (Kraft) | 50 | 83.91% | 6.09 | 0.98 | 4 |
| Refined Cellulose | 50 | 92.35% | 6.01 | 0.46 | 4 |
| Lignin D (Kraft) | 60 | 63.06% | 6.01 | 2.22 | 1 |
| Lignin E | 60 | 62.23% | 6.01 | 2.27 | 1 |
| Lignin E | 60 | 67.44% | 6.02 | 1.96 | 2 |
| Lignin E | 60 | 77.61% | 6.03 | 1.35 | 4 |

### Example 2: Semi-Batch Flow Through Reactor

Higher throughput thermochemical processing is more efficient and economical if the process is performed in a continuous fashion using counter-current or co-current flow with the solvent and feedstock. Counter-current processing would provide the lowest retention time of the solvent to minimize solvent decomposition while allowing the feedstock to continue to be digested and extracted. To simulate this kind of process, a semi-batch, or semi-continuous, thermochemical digestion of various lignocellulosic feedstocks was performed using the dry feedstock loaded into a reactor containing metal frits at the inlet and outlet. The frits restrained the feedstock and insoluble extraction residue produced during the process. The loaded reactor was connected to a system within a high temperature convection oven. The reactor assembly was pressurized to 300 psi with nitrogen and heated to 370° C. while the solvent was pumped through the packed bed of the feedstock. The pressure of the system was held constant using a backpressure regulator. The solvent containing soluble digested extracted material was pumped into a collection vessel. Then the collected material was drained into a separate vessel and vacuum distilled. All vacuum distilled products were dark brown to black in color. Select example data for thermochemical conversion using a semi-batch flow through reactor for various lignocellulosic feedstocks is presented in Table 2. These feedstocks consist of postconsumer waste materials, manufacturing waste, agricultural waste, and refined products.

TABLE 2
Select experimental data and extraction yield data using a semi-
batch flow through reactor to thermochemically digest various lignocellulosic
feedstocks from post-consumer waste, manufacturing waste, agricultural
waste, and commercial refined products.

| | Dodecanol | | | | Solvent |
|---|---|---|---|---|---|
| | Solvent | Extraction | Starting | Extraction | Flowrate |
| Feedstock | Volume (mL) | Yield (%) | Weight (g) | Residue (g) | (ml/hr) |
| Lignin A | 100 | 71.66% | 8.01 | 2.27 | 20 |
| Bagasse Lignin | 90 | 58.25% | 5.03 | 2.10 | 20 |
| Basic Earthable | 90 | 49.07% | 7.01 | 3.57 | 20 |
| Lignin | | | | | |
| Soy Hulls | 90 | 93.24% | 5.03 | 0.34 | 20 |
| Soy Hulls | 100 | 92.36% | 7.07 | 0.54 | 20 |
| Sawdust (Softwood) | 90 | 84.00% | 2.00 | 0.32 | 20 |
| Cardboard | 100 | 87.06% | 2.01 | 0.26 | 20 |
| Shredded Paper | 130 | 80.15% | 4.03 | 0.80 | 20 |
| Cotton Shirt | 100 | 88.71% | 2.48 | 0.28 | 20 |
| Algae | 100 | 86.49% | 7.03 | 0.95 | 20 |
| Hemp Bedding | 85 | 84.59% | 3.05 | 0.47 | 20 |

Note:
Basic Earthable Lignin contained a high amount of inorganic solids.

### Example 3: Lignin E Reaction Time Experiments

Two separate experiments were performed at two different reaction times. In the first experiment, 3.0 g of Lignin E was refluxed with 27.5 g lauric acid for 4 hrs under an inert atmosphere. During the first two hours, the lignin completely dissolved. The reaction was cooled and volatiles were vacuum distilled at a reduced pressure around 25 microns using an oil bath maintained at 250° C. The distilled residue was 3.2 g of product.

In the second experiment, 3.0 g of Lignin E was again refluxed with 27.5 g lauric acid, this time for 24 hrs under an inert atmosphere. During the first two hours, the lignin completely dissolved. The reaction was cooled and volatiles were vacuum distilled at a reduced pressure around 25 microns using an oil bath maintained at 250° C. The distilled residue was 4.6 g.

### Example 4-Compositional Characterization of Batch Reactor Products

Select lignocellulosic samples from the batch reactor vacuum distilled products were analyzed by the SAR-AD™ to provide compositional characterization. SAR-AD data for the lignocellulosic products and a petroleum asphalt control are given in Table 3. SAR-AD data shows that there are very little to no Sat (fully saturated hydrocarbons) or Aro 1 (1 ring aromatics substituted with alkyl groups) molecules present in the lignocellulosic products. This is consistent with these feedstocks since they do not contain long chain alkyl groups or oils, lipids, and other biomolecules containing significant saturated hydrocarbon moieties because these are generally removed from the original biomass during the processes that produce these feedstocks. One of the difficulties with petroleum asphalt products is that they often contain a significant amount of Sat and Aro 1 molecules. These molecules are incompatible with the heaviest, most aromatic, most polar, highest heteroatom content, and most self-associating Asphaltene molecules. Therefore, an imbalance between the asphaltene solvent phase (Aro 2, Aro 3, and Resins) and the two incompatible fractions cause homogenous petroleum asphalt products to become heterogenous (like immiscibility between oil and water) resulting in a loss of material integrity and failure. In general, lower Sat, Aro 1, and Asphaltenes are desired for more stable homogenous petroleum asphalt materials. For petroleum asphalt binder materials, this imbalance becomes more exaggerated with oxidative aging which converts primarily the Aro 2, Aro 3, and some Resins fraction into asphaltenes. Since the lignocellulosic asphalt binders do not contain destabilizing Sat, Aro 1, and little Aro 2 (2-3 fused aromatic rings with alkyl groups), it is expected that for asphalt binder applications, that these products may be more stable with overall better compatibility. This could also mean that these material may have greater stability during oxidative aging.

Of particular interest are the SAR-AD results from the Lignin A products under the same conditions except by varying the lignin to solvent ratio (1:9 and 1:3). For this lignin, a lower solvent ratio resulted in a product with a higher asphaltene content and a lower maltene content. This shows that the product quality for a given feedstock and solvent system can be easily tuned by the process conditions.

TABLE 3
SAR-AD data collected using an evaporative light scattering (ELS) detector
to quantify the weigh percent of each chemical class of molecules.

| | Maltenes | | | | | Asphaltenes | | | |
|---|---|---|---|---|---|---|---|---|---|
| Sample ID | Sat | Aro 1 | Aro 2 | Aro 3 | Resins | CyC₆ | Toluene | CH₂Cl₂ | Total |
| Asphalt QC (pre) | 14.01 | 8.34 | 23.62 | 26.21 | 13.82 | 4.00 | 9.76 | 0.24 | 14.00 |
| Lignin A | 0.58 | 0.94 | 8.99 | 28.53 | 48.82 | 1.26 | 10.65 | 0.22 | 12.14 |
| Lignin A (low | 0.13 | 0.17 | 4.17 | 17.43 | 42.82 | 3.00 | 31.74 | 0.52 | 35.27 |
| solvent) | | | | | | | | | |
| Lignin C (Kraft) | 0.00 | 0.06 | 1.00 | 5.66 | 25.20 | 1.70 | 61.78 | 4.61 | 68.08 |
| Refined | 0.27 | 0.23 | 6.07 | 28.71 | 40.98 | 4.51 | 19.15 | 0.09 | 23.76 |
| Cellulose | | | | | | | | | |
| Asphalt QC | 14.06 | 8.54 | 23.40 | 25.72 | 14.33 | 3.89 | 9.78 | 0.26 | 13.94 |
| (post) | | | | | | | | | |

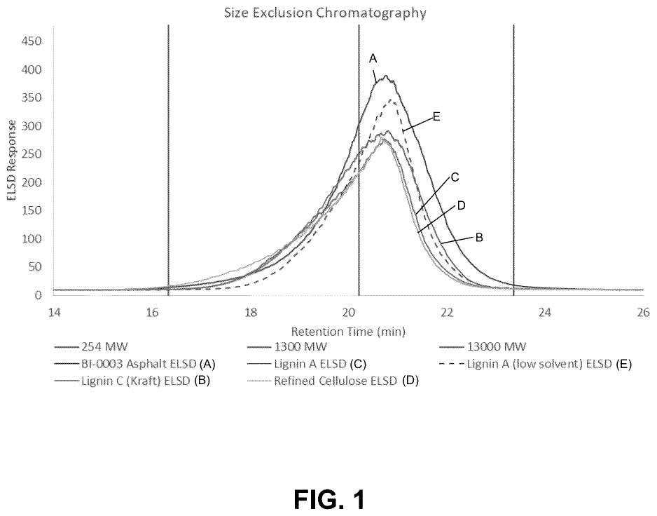

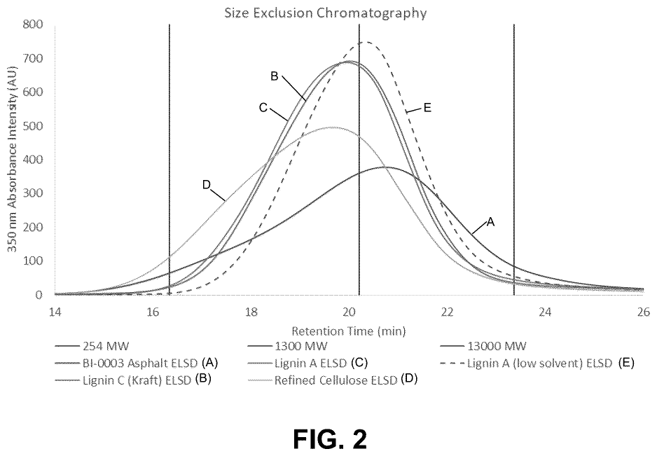

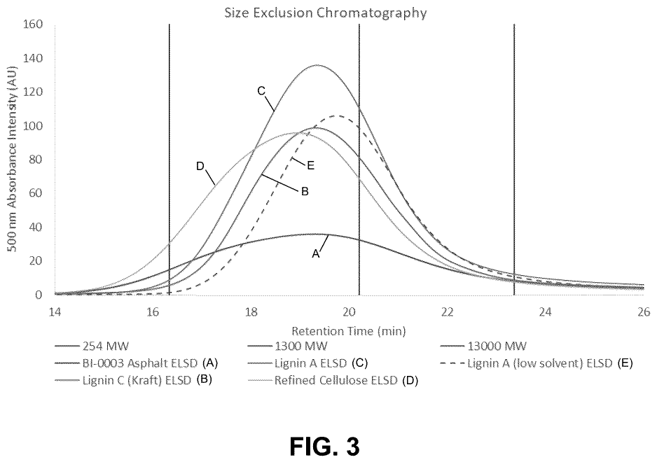

The viscoelastic response of petroleum asphalt materials is governed by the types of molecules present, their molecular structure, and their molecular weight (MW). Higher MW materials that are more aromatic or with significant n-paraffinic groups tend to lead to a loss in ductility—especially at low temperatures—and an increase in stiffness. The MW of the lignocellulosic products were determined using size exclusion chromatography (SEC) and these were compared to a standard PG 58-28 asphalt form the Holly Asphalt Company from the Cheyenne Holly Frontier refinery. SEC chromatograms using a ELS detector for select lignocellulosic products and the PG 58-28 asphalt are given in FIG. 1. The chromatograms show a very high overlap in the molecular size and distribution that is very similar to petroleum asphalt molecules. This suggests that the ductility and stiffness of the lignocellulosic products will be similar to petroleum asphalt. Characterization of the overall aromatics content (FIG. 2, using an optical absorbance detector at 350 nm) and the asphaltenes (FIG. 3, using an optical absorbance detector at 500 nm) are also very similar to the petroleum asphalt. Overall, the total aromatics content (350 nm) for the lignocellulosic products is slightly larger than petroleum, but still certainly within the normal range of molecular weights. The fact that the asphaltenes are also very similar in MW show that the produced asphaltenes do not undergo high levels of self-associations like asphaltenes produced upon aging, or are made up of large molecules such as those produced by the air blowing process of petroleum.

### Example 5: Rheological Characterization of Batch Reactor Products

The composition and MW data for the lignocellulosic products are similar to those of petroleum asphalt products. Likewise, rheological characterization for the materials also showed similar behavior over a large range of temperatures and frequencies. This was demonstrated by comparing the Black Space diagrams (plotting the complex modulus by the phase angle) for the Lignin A product (PG 67 continuous grade) from Table 1, produced with the higher amount of solvent, to the rheological response of a standard petroleum asphalt with a similar upper PG (PG69 continuous grade). At the lower temperature side of the data the Lignin A product appears to not have reached the glassy modulus at −30° C. which may mean that it will remain more flexible at lower temperatures. This appears to be confirmed by the Glover-Rowe parameter and the Pavel Kriz phase angle as shown in Table 4.

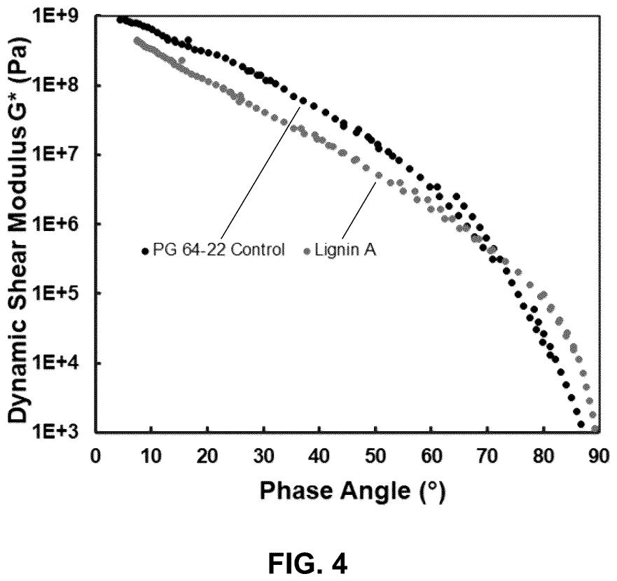

TABLE 4
Rheological parameters using 25 parallel plates (upper PG) and
4 mm parallel plates for the conditions described in FIG. 4.

Unaged Condition

| | High | Low | Glover- | Pavel |
|---|---|---|---|---|
| Sample | PG | PG | Rowe | Kriz |
| PG 64-22, | 68.9 | −35.9 | 1 | 54 |
| Control | | | | |
| Lignin A | 66.8 | −30.8 | 0.46 | 44 |

### Example 6: Extraction Residue Characterization

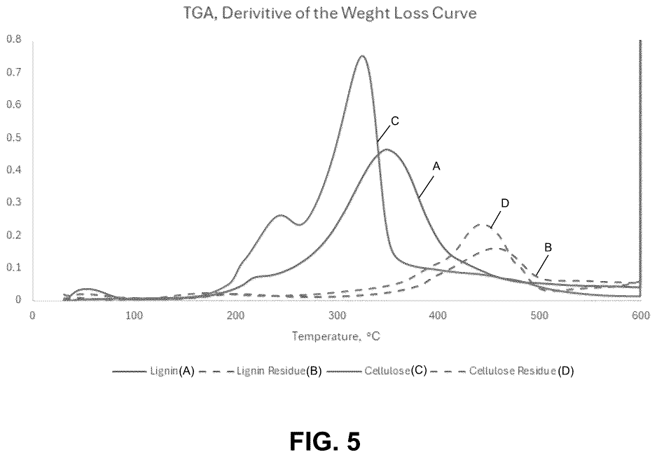

After the extraction process the insoluble solids were analyzed by thermogravimetric analysis (TGA). Weight loss data for various thermal events are provided in Table 5. In general, for the residues there is a significant enrichment in fixed carbon (coke-like) and inorganic content after the thermochemical extraction. These residues may have uses for soil amendments, chars, fillers, or fuels. FIG. 5 shows the derivative of the TGA weight loss curves which shows that after thermochemical extraction the residual organic content is much less reactive (less pyrolytic carbon).

TABLE 5
TGA data for lignin and cellulose feedstocks before and after the thermochemical process.

| | | 130-395° | 395-445° | 445-475° | 475-600° | | | |
|---|---|---|---|---|---|---|---|---|
| | 30-130° C. | C. | C. | C. | C. | 600° C. | | |
| Nitrogen | Moisture | Volatiles | Pyrolysis | Pyrolysis | Pyrolysis | Carbon Resid | Ash | Total |
| Sample Name | % | % | % | % | % | % | % | % |
| Lignin | 1.56 | 46.65 | 6.65 | 2.15 | 9.94 | 32.64 | 0.39 | 99.99 |
| Lignin Residue | 0.48 | 4.86 | 5.63 | 4.65 | 8.09 | 73.85 | 2.46 | 100.01 |
| Cellulose | 0.50 | 60.90 | 4.35 | 2.13 | 3.42 | 17.20 | 11.50 | 100.00 |
| Cellulose Residue | 1.18 | 8.07 | 8.55 | 5.70 | 5.58 | 21.05 | 49.89 | 100.01 |

### Example 7: Further Modification

During the flow through semi-batch processing the lower residence time of the solvent with the extracted products can cause the products to be significantly stiffer than those produced in the batch reactor with longer residence times between the solvent and extracted products. Although this softening at higher residence times is useful to tune the products it also decomposes the solvent. Using a two-stage approach to rapidly extract the product followed by post processing at a much lower temperature with the same solvent or a different solvent can help to conserve the solvent and improve its recyclability. Tuning of the product properties by further modification was demonstrated by taking the vacuum distilled flow through product from Lignin A which was a solid with an upper PG greater than 150° C. and combining it with fresh dodecanol and heating the mixture up under nitrogen to 370° C. with stirring. The reaction was allowed to proceed for 4 hours and the excess solvent was removed by vacuum distillation. The weight of the product increased by 35% through alkylation and etherification reactions. The resulting product was much softer with an upper PG of 36° C. as a viscous oil. In this approach the same solvent was used to do the additional modification, but other solvents with additional desirable properties may be used.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Certain molecules disclosed herein may contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every device, system, formulation, combination of components, or method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. A method of valorizing a lignocellulosic feedstock, the method comprising:
providing a lignocellulosic feedstock;
contacting the lignocellulosic feedstock with a bio-solvent at a temperature selected from the range of 120° C. to 450° C., thereby generating a liquid phase and a residue, the residue being an insoluble solid;
distilling the liquid phase, thereby generating a distillate and a product;
producing an asphalt binder material, wherein the asphalt binder material comprises the product.

2. The method of claim 1, comprising solvolysis of the lignocellulosic feedstock via the bio-solvent.

3. The method of claim 1 wherein the bio-solvent is derived from one or more agricultural crops.

4. The method of claim 1 wherein the bio-solvent comprises a C4 to C38 carbon chain.

5. The method of claim 1 wherein the bio-solvent comprises a C8 to C16 carbon chain.

6. The method of claim 1 wherein the bio-solvent comprises a C16 to C26 carbon chain.

7. The method of claim 1 wherein the bio-solvent comprises one or more fatty acids, anhydrides, fatty alcohols, fatty amines, fatty aldehydes, or combinations thereof.

8. The method of claim 1 wherein the bio-solvent is a bifunctional solvent.

9. The method of claim 1 comprising producing the bio-solvent from one or more agricultural crops.

10. The method of claim 1 wherein the lignocellulosic feedstock comprises cellulose, hemicellulose, lignin, or a combination thereof.

11. The method of claim 1 comprising preparing the lignocellulosic feedstock from a paper, construction, sawmill, or forestry waste stream.

12. The method of claim 1 wherein the lignocellulosic feedstock comprises corn stover, corn husks, wheat, rice, bamboo, strow, barley, palm, sugar cane, beet pulp, sorghum stalks, soybean straw, okara, potato waste, soybean hulls, flour, sugar cane bagasse, leaves, rice husks, grasses, wood, hemp, coco nut husks, cocoa waste, coffee plant and fruit waste, coffee grounds, manure, or combinations thereof.

13. The method of claim 1 wherein the lignocellulosic feedstock comprises paper waste, cardboard, natural fabrics or combinations thereof.

14. The method of claim 1 wherein the lignocellulosic feedstock comprises proteins, amino acids, nucleic acids, lipids, or combinations thereof.

15. The method of claim 1 wherein the lignocellulosic feedstock is derived from algae, bacteria, mold, fungus, and/or lichen.

16. The method of claim 1 wherein the contacting step occurs at a temperature selected from the range of 200° C. to 380° C.

17. The method of claim 1 wherein the contacting step occurs at a pressure selected from the range of 5 psig to 500 psig.

18. The method of claim 1 wherein the contacting step has a duration selected from the range of 1 minute to 480 minutes.

19. The method of claim 1 wherein the contacting and distilling steps are performed via batch processing.

20. The method of claim 1 wherein the contacting and distilling steps are performed via continuous processing.

21. The method of claim 1 comprising oxidizing the product via air or a chemical oxidizing agent.

22. The method of claim 1 comprising contacting the product with an antioxidant material.

23. The method of claim 22 wherein the antioxidant material comprises a phenolic antioxidant, a radical scavenger antioxidant, a sulfur-based antioxidant, a phospite-based antioxidant, a metal-based antioxidant, or a combination thereof.

24. The method of claim 1, wherein producing the asphalt binder material comprises blending the product with a polymer.

25. The method of claim 24 wherein the polymer is an SBS polymer or reactive terpolymer.

26. The method of claim 1 comprising producing a roofing material, asphalt, coating, or sealant using the asphalt binder material.

27. The method of claim 1 wherein the bio-solvent is a first bio-solvent, and wherein the contacting step comprises:
contacting the lignocellulosic feedstock with the first bio-solvent at a first temperature and for a first duration in a first extraction stage; and
contacting the lignocellulosic feedstock with the bio-solvent at a second temperature and for a second duration in a second extraction stage;
wherein the first temperature is at least 20° C. greater than the second temperature, and wherein the second duration is at least 1.2 times greater than the first duration.

28. The method of claim 27 wherein the first bio-solvent is the same as the second bio-solvent.

29. The method of claim 27 wherein the first bio-solvent is different than the second bio-solvent.
